(19) United States
(12) Patent Application Publication
(10) Pub. No.: US 2017/0231867 A1
(43) Pub. Date: Aug. 17, 2017

(54) MEDICATION PACKAGING AND DOSE REGIMEN SYSTEM

(71) Applicant: MYLAN INC., Canonsburg, PA (US)

(72) Inventors: Andrew MASTON, Pittsburgh, PA (US); Chad HOLLAND, Wexford, PA (US); Joanna TERHUNE, Pittsburgh, PA (US); Jeffrey WARDEN, Bala Cynwyd, PA (US)

(21) Appl. No.: 15/504,556

(22) PCT Filed: Aug. 18, 2015
(86) PCT No.: PCT/US15/45640

§ 371 Date: Feb. 16, 2017

Related U.S. Application Data
(60) Provisional application No. 62/039,025, filed on Aug. 19, 2014.
(60) Provisional application No. 62/039,104, filed on Aug. 19, 2014.

(51) Int. Cl. A61J 1/03; B65D 50/04; A61J 7/04; B65D 51/18; B65D 1/02; B65D 5/46; B65D 47/08; A61J 7/00; B65D 1/04

(52) U.S. Cl. CPC A61J 1/03; A61J 7/0084; B65D 50/04; A61J 7/04; B65D 1/04; B65D 1/0246; B65D 5/46112; B65D 47/0847; B65D 51/18; A61J 2205/30

(57) ABSTRACT

A medication container includes a body comprising a neck portion and defining a cavity that includes at least one compartment. At least one closure member disposed with the neck portion in alignment with at least one of the at least one compartment, the at least one closure member being rotatable relative to the body. The at least one closure member is movable between a medication accessible configuration and a tamper resistant configuration. Systems and methods of use are disclosed.

### CROSS-REFERENCE TO RELATED APPLICATION

This application claims the benefits of U.S. Provisional Patent Application No. 62/039,025 filed Aug. 19, 2014 and U.S. Provisional Patent Application No. 62/039,104 filed Aug. 19, 2014, the contents of each of these applications being hereby incorporated in their respective entireties by reference.

### TECHNICAL FIELD

The present disclosure generally relates to medicament packaging and more particularly to a dispensing device and system that provides a medication regimen and/or tamper resistance and a method for treatment of a medical condition.

### BACKGROUND

Retail customers and/or patients can be engaged in a medical therapy, which may include diet, exercise and/or a prescription and/or a non-prescription medication dosing regimen, which may be employed to treat an illness. In some cases, hospitalized patients are often discharged and instructed by one or more medical practitioners to comply with a medical therapy.

Such medication dosing regimen can include one or a plurality of medications administered over a regimen, which may include one or more medications. The medication dosing regimen can require administration of medications simultaneously, at different times and/or according to days of a week or time of day. Such medication regimens may be administered in addition to existing medication regimens that a user may take for nutritional, therapeutic and/or illness treatment.

Such medication regimens, however, often suffer from poor patient compliance. In fact, many patients fail to comply with their medication regimens. In some cases, life-style related medications may also suffer from poor user compliance. Factors that contribute to non-compliance may include complexity of medication regimen, patient failure in filling prescriptions, incorrect order and/or prescription, cost, adverse side effects, patient reluctance, lack of motivation, non-reconciliation with existing medication and/or patient physiological issues.

Various medications of a medication regimen can be dispensed from a medication container such as single dose and/or multiple dose blister packaging to a user with or without tamper resistance. Multiple dose blister packaging can dispense a single medication according to a regimen including day, e.g., Monday, Tuesday, etc. and/or time of day. This disclosure describes an improvement over these prior art technologies.

### SUMMARY

In one embodiment, medication container is provided. The medication container includes a body comprising a neck portion and defining a cavity that includes at least one compartment. At least one closure member is disposed with the neck portion in alignment with at least one of the at least one compartment. The at least one closure member is rotatable relative to the body. The at least one closure member is movable between a medication accessible configuration and a tamper resistant configuration. Systems and methods of use are disclosed.

### BRIEF DESCRIPTION OF THE DRAWINGS

The present disclosure will become more readily apparent from the specific description accompanied by the following drawings, in which:

FIG. 1 is a perspective view of components of one embodiment of a system in accordance with the principles of the present disclosure;

FIG. 2 is a perspective view of components of one embodiment of a system in accordance with the principles of the present disclosure;

FIG. 3 is a perspective view of components of one embodiment of a system in accordance with the principles of the present disclosure;

FIG. 4 is a perspective view of components of one embodiment of a system in accordance with the principles of the present disclosure;

FIG. 5 is a perspective view of components of one embodiment of a system in accordance with the principles of the present disclosure;

FIG. 6 is a perspective view of components of the system shown in FIG. 5;

FIG. 7 is a perspective view of the components of the system shown in FIG. 5;

FIG. 8 is a perspective view of components of one embodiment of a system in accordance with the principles of the present disclosure;

FIG. 9 is a perspective view of components of the system shown in FIG. 8;

FIG. 10 is a perspective view of components of the system shown in FIG. 8;

FIG. 11 is a perspective view of components of one embodiment of a system in accordance with the principles of the present disclosure;

FIG. 12 is a perspective view of components of the system shown in FIG. 11; and

FIG. 13 is a perspective view of components of the system shown in FIG. 11.

### DETAILED DESCRIPTION

The exemplary embodiments of a medicament dispensing system and related methods of use disclosed are discussed in terms of dispensing devices for the treatment of various diseases, illness and/or ailments and more particularly, in terms of a medicament dispensing device and system that provides a medication regimen and/or tamper resistance and a method for treatment of a medical condition. In some embodiments, the present system is employed with a method for distribution of medication packaging to a patient for treatment of one or more diseases, illness and/or ailments. In some embodiments, the present system is employed with a method such that a patient is discharged from a health care facility, for example, short term discharge and/or long term discharge.

In some embodiments, the present system comprises a medicament container and a packaging system and methods of use for storage, transportation and discharge of medications for the treatment of a medical condition. In one embodiment, the systems and methods of the present disclosure are employed to aid a person with a medical condition requiring the administration of multiple pills, doses, or schedules. In one embodiment, the systems and methods of the present disclosure include a medicament dispensing device that provides child-resistance while being easily accessed by an adult. In some embodiments, the present system comprises a medicament dispensing system and methods of use for storage, transportation and discharge of medications including those for treating illnesses, such as, for example, myocardial infarction, elevated blood pressure, dyslipidemia (high cholesterol), diabetes, metabolic syndrome, heart failure, pneumonia, cardiac deficiencies, arthritis, illnesses in which pain is part of an on-going treatment plan, and/or life-style related medications such as, for example, birth control pills, hormone replacement pills and nutritional supplements, such as, for example, neutraceuticals, for example, having vitamin A, D, and E with a calcium supplement.

In some embodiments, the system includes a container body having a threaded screw top to engage a child-resistant lid. In one embodiment, the container body has a neck portion having threads to engage the lid. In one embodiment, the container body includes a cavity that is divided into compartments by partitions. In one embodiment, each of the compartments is covered by a flip top to provide access to the compartment when opened. In various embodiments, the container body comprises four compartments and four flip tops. In various embodiments, the medicament dispersing system includes a speed loader insertable into each compartment to load the compartments with medicaments.

In some embodiments, the system is partially or entirely filled and built by a pharmacist. In some embodiments, the medicament dispensing system comprises a resilient material. In some embodiments, the medicament dispensing system provides child-resistance and is easily accessible by an adult. In various embodiments, a method for accessing the medicaments held within the medicament dispensing system is provided. The method requires consecutive and/or simultaneous motions difficult for children to perform and simple for an adult to perform.

In some embodiments, the system is employed with a method for distribution of medication packaging to a patient for treatment of one or more diseases, illness and/or ailments. In some embodiments, the present system is employed with a method such that a patient is discharged from a health care facility, for example, short term discharge and/or long term discharge.

In one embodiment, the system is employed with a method such that a patient is discharged from a health care facility, such as, for example, a hospital after one or more diseases, illness and/or ailments, such as, for example, myocardial infarction and may be prescribed one or more medications. In some embodiments, a patient may be directed and/or prescribed medication, such as, for example, an antiplatelet agent, aspirin, a beta-blocker, an ACE inhibitor, an ARB statin, nitro-glycerin, a docusate and/or anti-depressants. In some embodiments, the system is employed to avoid failure of a patient to comply with such regimens and/or to take medications as prescribed or directed. In some embodiments, compliance failure can include the patient failing to refill the prescription, forgetting to take the prescribed medication, incomplete dosage and/or taking the medication at the incorrect time. In some embodiments, the present system is employed with a method for chronic dosing, for example, 30 day scripts or 90-100 day mail order refills. In some embodiments, the system is employed with a method to facilitate compliance. In some embodiments, the system is employed with a method to display and/or prove compliance. For example, a patient attending a practitioner appointment provides a present system, such as, for example, a compliance pack and displaying and/or showing the practitioner use of the compliance pack, which may include rupture of one or more blister packs to evidence compliance, as described herein. In some embodiments, the system is employed with a method for distribution of medication packaging to a patient for treatment of one or more diseases, illness and/or ailments, such as, for example, pneumonia, heart failure, pain, infectious diseases that may include administration of medications, such as, for example, anti-retrovirals (ARV) for treatment of HIV/AIDS, dyslipidemia (high cholesterol), hypertension (high blood pressure), metabolic syndrome/insulin intolerance related to diabetes, psychological diseases and/or administration of transplant/anti-rejection drugs.

In some embodiments, the method includes treatment of a heart condition following a myocardial infarction. In some embodiments, the present system comprises a medicament dispensing system and methods of use for storage, transportation and discharge of medications including those for treating illnesses, such as, for example, elevated blood pressure, dyslipidemia (high cholesterol), diabetes, metabolic syndrome, heart failure, pneumonia, cardiac deficiencies, arthritis, illnesses in which pain is part of an on-going treatment plan, and/or life-style related medications such as, for example, birth control pills, hormone replacement pills and nutritional supplements, such as, for example, neutraceuticals, for example, having vitamin A, D, and E with a calcium supplement. In one embodiment, the systems and methods of the present disclosure are employed to aid a person with a medical condition requiring administration of multiple pills, doses or schedules as part of a regimen. In one embodiment, the systems and methods of the present disclosure include a medicament dispensing device that provides tamper resistance, such as, for example, child resistance, while being easily accessed by an adult.

In one embodiment, the system provides a complex dosage regimen for medications for a period of time, such as, for example, two weeks. In some embodiments, one or more blister cards are provided pre-filled with medication, as described herein, from a manufacturer. In some embodiments, a practitioner, such as, for example, a pharmacist determines and selects one or more of the pre-filled blister cards based on doctor's prescription and creates the medication container. In some embodiments, the manufacturer provides a medication container packed with selected blister cards and pre-filled medication according to the doctor's prescription. In some embodiments, the complex dosage regimen for the medications is provided for a period lasting until a patient's first outpatient visit following release from a hospital. In one embodiment, one or more medications are included in a medicament dispensing system. In one embodiment, medications prescribed to a patient following a medical procedure are included in a medicament dispensing system. In one embodiment, medications previously being taken by a patient are included in a medicament dispensing system.

In some embodiments, the system includes a medicament dispensing container, such as, for example a collapsible box. The collapsible box includes an interior space configured to receive medications. In some embodiments, the medications may be contained in bottles, amber vials, syringes and/or pill organizers. In some embodiments, the interior space of the collapsible box contains information inserts or literature directed to the medications in a patient's complex dosage regimen. In some embodiments, the collapsible box may include a decorative design on an outer surface. In some embodiments, the collapsible box may be translucent or semi-translucent to allow a patient to view its contents.

In some embodiments, the system is partially or entirely filled and packaged by a pharmacist. In some embodiments, the medicament dispensing system provides a child-resistant package while being easily accessible by an adult. In some embodiments, a method for accessing medication within the medicament dispensing system is provided. In some embodiments, the method includes the step of requiring consecutive and/or simultaneous motions difficult for children to perform but simple for an adult to perform. In one embodiment, the medication packaging comprises a closing mechanism having interlocking enclosure members.

In one embodiment, the system includes a medication treatment regimen comprising a plurality of medications. In one embodiment, the medicament dispensing system provides an organization of each medication in a patient's treatment regimen. In one embodiment, each distinct medication in the regimen is stored in separate bottles and/or pill organizers contained in a medicament packaging container. In one embodiment, the system is employed with a method that includes fourteen days of therapy provided on each unit dose page. In one embodiment, medication packaging includes one or more unit dose pages assembled, filled and sealed by a pharmacist.

The present disclosure may be understood more readily by reference to the following detailed description of the embodiments taken in connection with the accompanying drawing figures, which form a part of this disclosure. It is to be understood that this application is not limited to the specific devices, methods, conditions or parameters described and/or shown herein, and that the terminology used herein is for the purpose of describing particular embodiments by way of example only and is not intended to be limiting. In some embodiments, as used in the specification and including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment. It is also understood that all spatial references, such as, for example, horizontal, vertical, top, upper, lower, bottom, left and right, are for illustrative purposes only and can be varied within the scope of the disclosure. For example, the references “upper” and “lower” are relative and used only in the context to the other, and are not necessarily “superior” and “inferior”.

As used in the specification and including the appended claims, “treating” or “treatment” of a disease or condition may include administering one or more medications to a patient (human or other mammal). Alleviation can occur prior to signs or symptoms of the disease or condition appearing, as well as after their appearance. Thus, treating or treatment includes preventing or prevention of disease or undesirable condition (e.g., preventing the disease from occurring in a patient, who may be predisposed to the disease but has not yet been diagnosed as having it). In addition, treating or treatment does not require complete alleviation of signs or symptoms, does not require a cure, and specifically includes procedures that have only a marginal effect on the patient. Treatment can include inhibiting the disease, e.g., arresting its development, or relieving the disease, e.g., causing regression of the disease. For example, treatment includes, but is not limited to, reducing acute or chronic inflammation, inducing an anti-platelet effect, reducing hypertension, and lowering cholesterol.

In some embodiments, a biologically-active substance includes any substance or substances comprising a medicament, medication or drug including an active therapeutic substance, metabolite, hormone, steroid, vitamin, fatty acid, amino acid, sugar, carbohydrate, polypeptide or mineral. In some embodiments, a biologically-active substance includes any substance used for treatment, prevention, diagnosis, cure or mitigation of disease or illness. In some embodiments, a biologically-active substance includes any substance that affects anatomical structure or physiological function. In some embodiments, a biologically-active substance includes any substance that alters the impact of external influences on an animal, or metabolite thereof. In some embodiments, a complex dosing regimen includes a systematic administration of multiple dosage units at designated times during the day. In some embodiments, a dose includes each individual release of substance into body tissue.

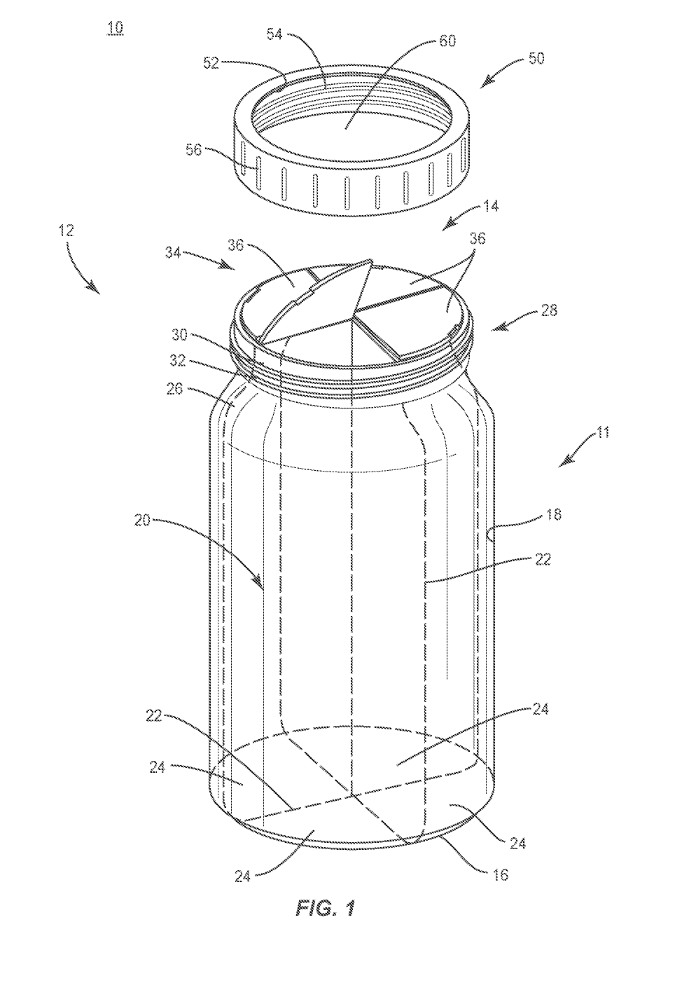

The following discussion includes a description of a medicament dispensing system including a medicament dispensing container, related components and methods of employing the medicament dispensing system. Alternate embodiments are also disclosed. Reference is made in detail to the exemplary embodiments of the present disclosure, which are illustrated in the accompanying figures. Turning to FIGS. 1-4, there are illustrated components of a medicament dispensing system 10.

The components of medicament dispensing system 10, individually or collectively, can be fabricated from materials suitable for storage and dispensing of medication. In some embodiments, such materials include metals, ceramics, synthetic polymers such as thermoplastics, semi-rigid and rigid materials, elastomers, fabric and/or their composites. Various components of medicament dispensing system 10 may have material composites, including the above materials, to achieve various desired characteristics such as strength, rigidity, elasticity, compliance, and durability. The components of medicament dispensing system 10, individually or collectively, may also be fabricated from a heterogeneous material such as a combination of two or more of the above-described materials. The components of medicament dispensing system 10 may be monolithically formed, integrally connected or include fastening elements and/or instruments, as described herein.

Medicament dispensing system 10 includes a medication container 11. Medication container 11 includes a container body 12. Body 12 includes an opening 14 and a base 16. In some embodiments, body 12 includes a circular cross-section. In some embodiments, body 12 may include cross-section shapes, such as, for example, round, partially cylindrical, oval, rectangular, polygonal, irregular, tapered, offset, staggered, uniform and non-uniform.

Body 12 includes a surface 18 that defines a cavity 20. Cavity 20 is configured to receive medications, such as, for example, dosage units as part of a medication dosage regimen. In some embodiments, cavity 20 includes partitions 22. Partitions 22 are configured to divide cavity 20 into compartments 24 by partitions 22. In some embodiments, as shown in FIG. 1, cavity 20 is divided into four compartments 24. Each compartment 24 is equally dimensioned and divides cavity 20 into fourths. In some embodiments, cavity 20 is divided into one or more compartments by one or more partitions 22, such as, for example, body 12 can include two compartments separated by a single partition, or body 12 can include three compartments 24 separated by a plurality of partitions 22. In some embodiments, compartments 24 can be variously and/or differently dimensioned and configured for disposal of one or more medications. In some embodiments, compartments 24 are sized to receive a number of medications required by a dosage regimen. In some embodiments, body 12 is transparent or semi-transparent to facilitate a patient monitoring the remaining amount of medications in compartments 24. In some embodiments, body 12 includes one or more cartridges that contain one or more medications and are dimensioned and configured for disposal in one or more compartments, as described herein. The cartridges may be disposable, refillable and/or configured for a single, one-time use. The cartridges can be inserted with one or more compartments for refills, ease of implementation at a pharmacy and/or cleanliness. In some embodiments, body 12 can be provided in a medication filled configuration from a manufacturer and/or a medication filled configuration from a pharmacist or assembled in part by the pharmacist, for example, pre-filled cassettes. In some embodiments, body 12 includes one or more pie-shaped insertable cartridges, each loaded with one or more medications, which can be slid and/or friction fit with walls of body 12. In some embodiments, body 12 includes a partitioned lid that locks the cartridges in place and allows access to the medication(s).

Body 12 includes a surface 26 that is configured to facilitate gripping by a user to access the medications stored therein. In some embodiments, surface 26 may have alternate surface configurations, such as, for example, rough, arcuate, undulating, mesh, porous, semi-porous, dimpled and/or textured to facilitate gripping by a patient. In some embodiments surface 26 has various ergonomic qualities, such as, for example, rubberized inserts or grooves to conform to a user's grip. In some embodiments, body 12 may comprise indicia on surface 26 (not shown). In various embodiments, the indicia provides the time and order in which the medications are to be taken by the patient. In one embodiment, body 12 is labeled to indicate the day of the dosage regimen the medication should be taken. The indicia may include graphics to indicate the time of day the medication should be taken. In various embodiments, the indicia are screen printed on body 12. In some embodiments, the indicia may be hand written. In some embodiments, a sticker containing the indicia may be adhered to a portion of body 12.

Body 12 includes a neck portion 28. Neck portion 28 extends from body 12 and includes a surface 30. In some embodiments, surface 30 includes threads 32. In some embodiments, threads 32 may include a single thread turn or a plurality of discrete threads. In some embodiments, threads 32 comprise child-resistant features, such as, for example, a gap in threads 32 to correspond with a tab in the threads of a lid, as discussed herein.

In some embodiments, body 12 includes a cover 34. Cover 34 is positioned in opening 14 and includes closure members 36. Members 36 are rotatably engaged, such as, for example, by a hinge 38 to an adjacent member 36 to facilitate opening of each compartment 24. Hinge 38 is configured to facilitate pivoting of members 36. In some embodiments, hinge 38 may include a crimp having a greater flexibility than member 36 to facilitate pivotable movement of member 36 relative to body 12. In some embodiments, hinge 38 may include alternate configurations, such as, for example, a friction hinge, a butt hinge, an enclosure hinge, living hinge or a line of perforations.

Each member 36 is rotatable relative to body 12 via hinges 38 to pivot between an open or non-locked configuration, such as, for example a medication accessible configuration and a closed or locked configuration, such as, for example, a tamper resistant configuration, as shown in FIG. 1. In the open configuration, member 36 is rotated away from body 12 to facilitate patient access to the medications stored within a corresponding compartment 24. In the closed configuration, member 36 prevents medications from being accessed, poured or spilled out of body 12.

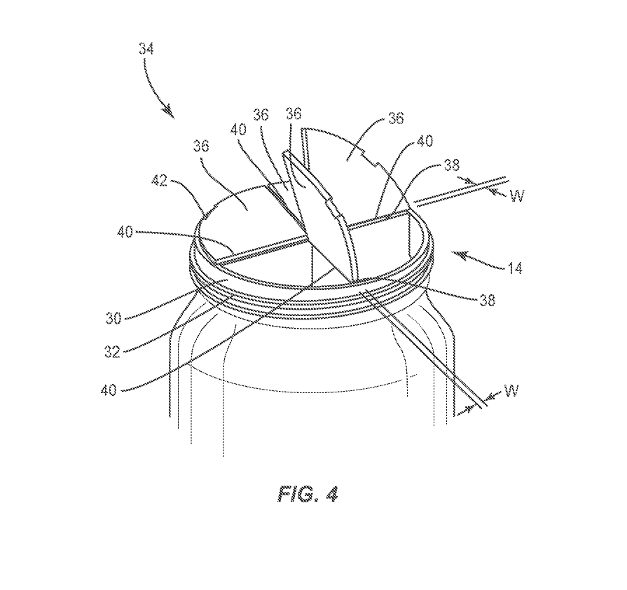

In some embodiments, members 36 are sized to fit over compartments 24 such that compartments 24 can be opened one at a time. In some embodiments, as shown in FIGS. 1 and 4, cover 34 includes four members 36 aligned with compartments 24. In some embodiments, members 36 include a shape corresponding to the cross-section of compartments 24. In some embodiments, body 12 comprises one or more members 36 corresponding to the number, size and/or configuration of the compartments 24, as described herein. In some embodiments, members 36 are configured such that one member 36 fits over more than one compartment 24. In some embodiments, cover 34 comprises two members 36 and four compartments 24 such that each of the two members 36 covers two adjacent compartments 24.

In some embodiments, members 36 include indicia. In some embodiments, the indicia indicate the name and/or nature of the medication being administered in the corresponding compartment 24. In some embodiments, the indicia include a list of possible side effects of the medication being administered in the corresponding compartment 24. In some embodiments, the indicia provide instructions on how long a patient should take the medication being administered in the corresponding compartment 24. In some embodiments, the indicia may provide color coding to differentiate the medications held within the various compartments 24. In some embodiments, the indicia may be screen printed or hand written onto members 36.

In some embodiments, cover 34 includes supports 40. In one embodiment, supports 40 are aligned with partitions 22. In some embodiments, supports 40 are positioned at an end of partitions 22 adjacent opening 14. As shown in FIGS. 3 and 4, cover 34 includes four supports 40 extending across opening 14 positioned to support members 36. In one embodiment, supports 40 have a width w configured to support adjacent edges of adjacent members 36 such that each support 40 contacts two members 36. In some embodiments, cover 34 may include one or more supports 40. In some embodiments, cover 34 includes two perpendicular supports 40 extending across opening 14.

Members 36 each include an indentation 42 to facilitate gripping and opening of members 36. In some embodiments, each member 36 is configured for locking in the closed configuration. In some embodiments, members 36 each include a locking mechanism, such as, for example, a flange (not shown) configured to provide a snap fit with neck portion 28.

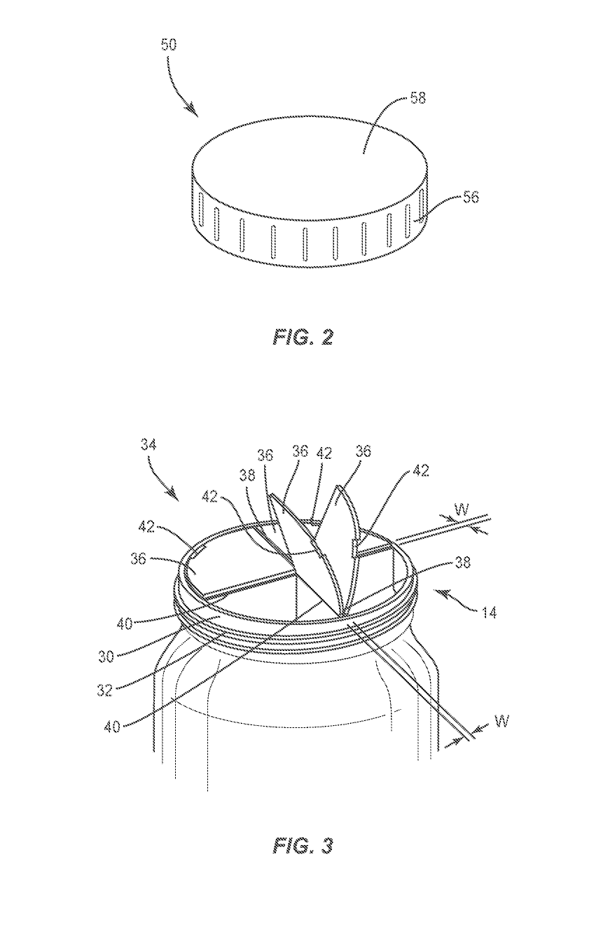

In some embodiments, medicament dispensing system 10 includes a lid 50. Lid 50 includes an inner surface 52 having threads 54 engageable with threads 32. In some embodiments, threads 54 may include a single thread turn or a plurality of discrete threads to conform to threads 32. Lid 50 includes an outer surface 56 having ridges configured to facilitate gripping by a patient. In some embodiments, surface 56 may have alternate surface configurations, such as, for example, rough, arcuate, undulating, mesh, porous, semi-porous, dimpled and/or textured to facilitate gripping by a patient. In some embodiments, as shown in FIG. 2, lid 50 comprises a top surface 58 configured to encase the entirety of cover 50. In some embodiments, as shown in FIG. 1, lid 50 comprises a transparent material or an opening 60 to allow the patient to view the indicia disposed on members 36.

In some embodiments, lid 50 includes child-resistant features to prevent a child from removing lid 50 from body 12. In some embodiments, removal of lid 50 requires a patient to push down and rotate relative to body 12. In some embodiments, removal of lid 50 requires a patient to squeeze opposite sides of surface 56 and rotate lid 50 relative to body 12. In some embodiment, removal of lid 50 requires a patient to rotate lid 50 relative to body 12 to align notches (not shown) on lid 50 and body 12 and then pull lid 50 from body 12. In some embodiments, lid 50 is provided with instructions to aid a patient in removal from body 12. The instructions may be presented in the form of a graphic, such as, for example, an arrow with a lock, or text, such as, for example, “press down and turn”. In some embodiments, the instructions may be printed onto lid 50.

In some embodiments, body 12 comprises a disposable dispensing device that provides therapeutic and/or nutritional support to an animal by increasing compliance with a dosing regimen. In some embodiments, body 12 and/or one or more compartments 24 comprise a plurality of receptacles. In some embodiments, each receptacle accommodates a dosage unit and isolates that dosage unit from other dosage units. In some embodiments, a biologically-active substance within each dosage unit will not come into contact with the biologically-active substance of other dosage units.

In some embodiments, a dose of medicament, medication or drug can include, such as, for example, a chewable tablet, quick dissolve tablet, effervescent tablet, reconstitutable powder, elixir, liquid, solution, suspension, emulsion, tablet, multi-layer tablet, bi-layer tablet, capsule, soft gelatin capsule, hard gelatin capsule, caplet, lozenge, chewable lozenge, bead, powder, granules, dispersible granules, cachets, douche, suppository, cream, topical, inhalant, aerosol inhalant, patch, particle inhalant, implant, depot implant, dragee, ampoule, ingestible, injectable, infusion, health bar, liquid, food, nutritive food, functional food, yogurt, gelatin, cereal, cereal coating, animal feed and/or combinations thereof.

In some embodiments, indicia of a medication regimen, direction, instruction and/or prescription for administration of a medication regimen may include dosage day indicia, a specific day of the week, such as Monday, Tuesday, Wednesday, Thursday, Friday, Saturday, Sunday or an abbreviation of said day, a specific date or a general succession of days, such as day 1, day 2, day 3. In some embodiments, indicia may include time indicia that may be, such as, for example, a general time of the day corresponding to each of compartments 24 or a specific time of the day corresponding to each of compartments 24, such as, for example, AM, PM, morning, afternoon, evening, day, night, daytime, nighttime and combinations thereof. In some embodiments, indicia may include each separate row or column on body 12 indicating a time of day, such as AM doses and PM doses. In some embodiments, body 12 and/or compartments 24 may be color coded for time indicia. In some embodiments, one or more components of medicament dispensing system 10 may include a key defining or explaining color coding.

In some embodiments, a dose of medicament, medication or drug may comprise vitamin A, B vitamins, vitamin C, vitamin D, vitamin E, vitamin K, essential fatty acids, folic acid, iron, calcium, magnesium, potassium, copper, chromium, zinc, molybdenum, iodine, boron, selenium, manganese, derivatives thereof and/or combinations thereof. In some embodiments, biologically-active substances may include thiamin, thiamin pyrophosphate, riboflavin, flavin mononucleotide, flavin adenine dinucleotide, niacin, nicotinic acid, nicotinamide, niacinamide, nicotinamide adenine dinucleotide, tryptophan, biotin, pantothenic acid, ascorbic acid, retinol, retinal, retinoic acid, beta-carotene, 1,25-dihydroxycholecalciferol, 7-dehyrdocholesterol, alpha-tocopherol, tocopherol, tocotrienol, menadione, menaquinone, phylloquinone, naphthoquinone, calcium, calcium carbonate, calcium sulfate, calcium oxide, calcium hydroxide, calcium apatite, calcium citrate-malate, calcium gluconate, calcium lactate, calcium phosphate, calcium levulinate, phosphorus, potassium, sulfur, sodium, docusate sodium, chloride, magnesium, magnesium stearate, magnesium carbonate, magnesium oxide, magnesium hydroxide, magnesium sulfate, copper, iodine, zinc, chromium, molybdenum, carbonyl iron, ferrous fumarate, polysaccharide iron, and/or combinations and derivatives thereof.

In some embodiments, a dose of medicament, medication or drug may be prescription and/or non-prescription substances. In some embodiments, the prescription substance may be a hormone replacement agent, a contraceptive agent, an osteoporotic agent, a chemotherapeutic agent, an anti-infective agent, analgesic, a steroid, an appetite suppressant, a weight loss agent, a tobacco antagonist, a cholesterol reducer and/or combinations thereof.

In some embodiments, the prescription substances may include, such as, for example, erythromycin, penicillins, cephalosporins, theophylline, albuterol, terbutaline, diltiazem, propranolol, nifedepine, clonidine, thioridazine, diazepam, meclizine, ergoloid mesylates, chlorpromazine, carbidopa, levodopa, beclomethasone diproprionate, budesonide, dexamehasone, flunisolide, fluticasone proprionate, mometasone furoate, triamcinolone acetonide, beconase, pulmicort, rhinocort, decadron, aerobid/nasolide, flovent/flonase, azmacort, amprenavir, adefovir dipivoxil, zidovudine, azidothymidine, AZT, paclitaxel, cyclophosphamide, teniposide, taxol, cytoxan, vumon, methotrexate, methotrexate, cisplatin, carboplatin, oxaliplatin, platinol, paraplatin, adriamycin, bleomycin, dactinomycin, daunorubicin, doxorubicin, indarubicin, mitomycin, blenoxane, cosmegen, cerubidine, rubex, indamycin, mutamycin, BCNU, streptozocin, vinblastine, thiotepa, conjugated estrogens, esterified estrogens, estropipate, estradiol, ethinyl estradiol, medroxyprogesterone, meprobamate, desogestrel, levonorgestrel, norethindrone, norethindrone acetate, norgestimate, norgestrel, raloxifene, tamoxifen, methyltestosterone, quinapril, losartan, sotalol, alendronate, atorvastatin, colestipol, clofibrate, and/or combinations thereof.

In some embodiments, the non-prescription substance can be a vitamin or derivative thereof, and/or a mineral compound or derivative thereof. In some embodiments, the vitamin or mineral compound may be, such as, for example, thiamin, thiamin pyrophosphate, riboflavin, flavin mononucleoride, flavin adenine dinucleotide, niacin, nicotinic acid, nicotinamide, niacinamide, nicotinamide adenine dinucleotide, tryptophan, biotin, folic acid, pantothenic acid, ascorbic acid, retinol, retinal, retinoic acid, beta-carotene, 1,25-dihydroxycholecalciferol, 7-dehydrocholesterol, alpha-tocopherol, tocopherol, tocotrienol, menadione, menaquinone, phylloquinone, naphthoquinone, calcium, calcium carbonate, calcium sulfate, calcium oxide, calcium hydroxide, calcium apatite, calcium citrate-malate, calcium gluconate, calcium lactate, calcium phosphate, calcium levulinate, phosphorus, potassium, sulfur, sodium, docusate sodium, chloride, magnesium, magnesium stearate, magnesium carbonate, magnesium oxide, magnesium hydroxide, magnesium sulfate, copper, iodine, zinc, chromium, molybdenum, carbonyl iron, ferrous fumarate, polysaccharide iron, and combinations and derivatives thereof. In some embodiments, the derivatives of vitamin compounds include salts, alkaline salts, esters and chelates of any vitamin compound. In some embodiments, the nonprescription substance can be a herbal compound, herbal extract, derivative thereof and/or combinations thereof.

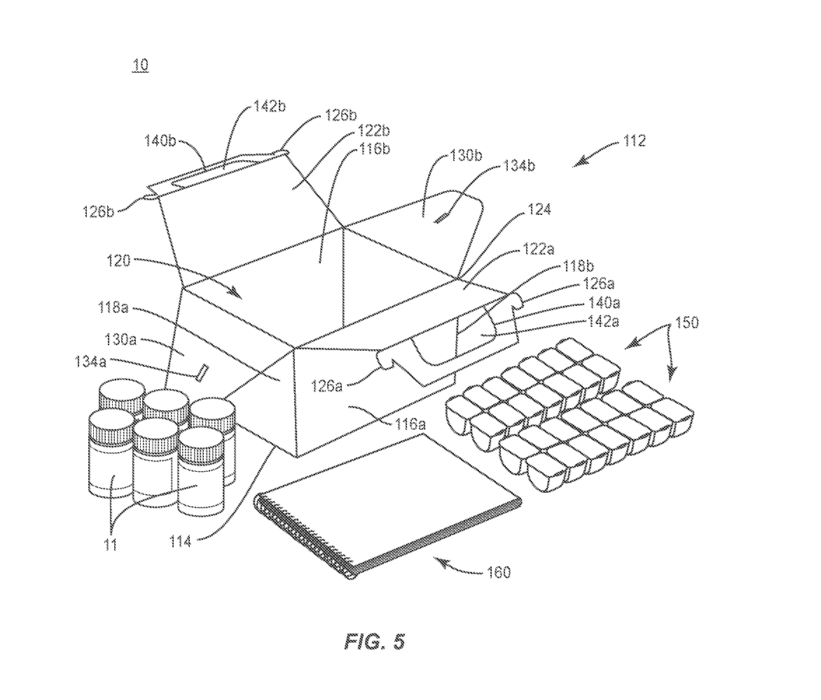

In some embodiments, as shown in FIGS. 5-7, medicament dispensing system 10, similar to the systems and methods of use of system 10 described herein, includes a medicament dispensing device, such as, for example, a medicament packaging 112. Medicament packaging 112 is configured for disposal of one or a plurality of medication containers including a bottle and a cap. In some embodiments, medication containers include, such as, for example, medication containers 11, as described herein. Medicament packaging 112 includes a bottom portion 114 and two pairs of oppositely positioned walls 116a, 116b, 118a, 118b. In some embodiments, medicament packaging 112 is configured as a foldable box. Portion 114 and walls 116a, 116b, 118a, 118b define a cavity 120. Cavity 120 is sized to receive medicaments stored in medication containers 11, pill organizers 150 and/or an insert 160, as discussed herein. Walls 116 are spaced apart from one another by a first distance, and walls 118 are spaced apart from one another by a second distance. In one embodiment, the first distance is greater than the second distance such that walls 116a, 116b, 118a, 118b have a rectangular cross-sectional configuration. In other embodiments, the first and second distances are equal such that walls 116a, 116b, 118a, 118b have a square cross-sectional configuration.

Medicament packaging 112 includes enclosure members, such as, for example, engagement flaps 122a, 122b, 130a, 130b attached to walls 116a, 116b, 118a, 118b, respectively. Flaps 122a, 122b are rotatable relative to walls 116a, 116b through an angular range of 0 through 360 degrees. In some embodiments, flaps 122a, 122b include a tapered profile to facilitate engagement with flaps 130a, 130b. In some embodiments, a locking element, such as, for example, tabs 126a, 126b are disposed at opposite ends of flaps 122a, 122b. In some embodiments, as shown in FIG. 5, tabs 126a, 126b are rounded to facilitated engagement with an opening, such as, for example, slots 134a, 134b disposed with flaps 130a, 130b, as discussed herein. In some embodiments, tabs 126a, 126b may include alternate configurations, such as, for example, oval, oblong, triangular, rectangular, square, polygonal, irregular, uniform, non-uniform, variable, tubular and/or tapered.

In some embodiments, flaps 122a, 122b include a surface 140a, 140b that define an opening 142a, 142b to facilitate gripping by a user and to enhance the portability of medicament packaging 112. Engagement of surfaces 140a, 140b defines a handle portion 144. In some embodiments, flap 122 includes a folding line to allow handle portion 144 to fold relative to flap 122. In some embodiments, the folding line may be a crease, a perforation or a breaking line.

In some embodiments, flaps 130a, 130b are attached to walls 118a, 118b, respectively. Flaps 130a, 130 are rotatable relative to walls 118a, 118b through an angular range of 0 through 360 degrees. In some embodiments, flaps 130a, 130b include a tapered profile to facilitate engagement with flaps 122a, 122b. Flaps 130a, 130b include slots 134a, 134b configured to receive tabs 126a, 126b. In some embodiments, slots 134 are sized to receive one tab 126 from each flap 122a, 122b.

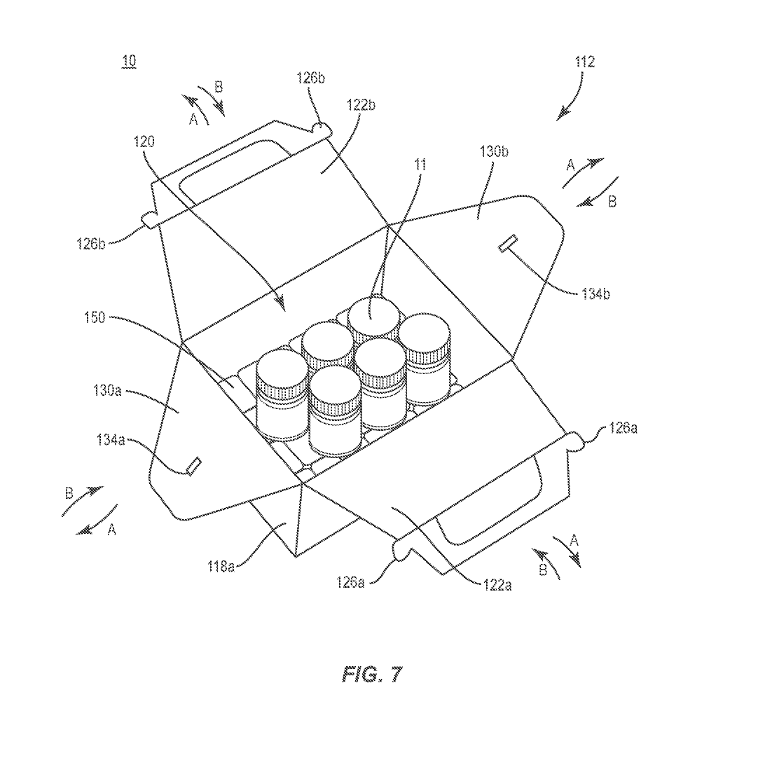

Flaps 122a, 122b, 130a, 130b are rotatable between an open position, such as, for example, a medication accessible configuration and a closed position, such as, for example, a tamper resistant configuration. In the closed configuration, portion 114, walls 116a, 116b, 118a, 118b and flaps 122a, 122b, 130a, 130b define a substantially enclosed cavity to prevent access to contents of medicament dispensing containers, such as, for example, medication containers 11 and/or pill organizers 150. In some embodiments, flaps 122a, 122b, 130a, 130b are biased to the open position. In some embodiments, in a closed configuration, flaps 122a, 122b, 130a, 130b provide a child-resistant medicament dispensing container. In an open configuration, flaps 122a, 122b, 130a, 130b are rotated relative to walls 116a, 116b, 118a, 118b, in a direction shown by arrows A in FIG. 7, such that cavity 120 of medicament packaging 112 is exposed to facilitate ease of access to the contents of cavity 120 of medicament packaging 112.

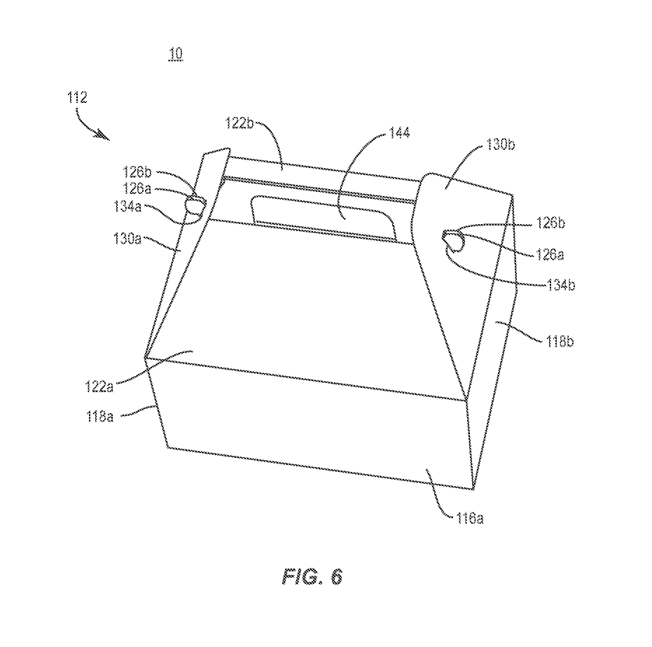

To close medicament packaging 112, flaps 122a, 122b, 130a, 130b are rotated relative to walls 116a, 116b, 118a, 118b, in a direction shown by arrows B in FIG. 7, such that cavity 120 of medicament packaging 112 is closed. In the closed configuration, surfaces 140, 140b converge to form handle 144, as shown in FIG. 6. Slots 134a, 134b are aligned with tabs 126a, 126b to lock medicament packaging 112. As medicament packaging 112 is moved between the open configuration and the closed configuration, engagement of tabs 126a, 126b with slots 134a, 134b causes tabs 126a, 126b to bow and/or flex to fit into slot 134. In some embodiments, tabs 126a, 126b include a hook configuration to engage slots 134a, 134b, such that a user presses down on handle 144 to separate tabs 126a, 126b from slots 134a, 134b.

In various embodiments, medicament packaging 112 may comprise instructions 160 configured to aid a user patient in use of medicament packaging 112. The instructions may be presented in the form of a graphic, such as, for example, an arrow, or text, such as, for example, “push here”. In some embodiments, the instructions may be printed onto a surface of flaps 122a, 122b, 130a and/or 130b. In some embodiments, the instructions may be printed onto one or more of walls 116a, 116b, 118a, and/or 118b.

In some embodiments, pill organizer 150 comprises receptacles. Each receptacle includes a pocket and a cap. The cap is rotatable relative to the pocket and moves between open and closed configurations. In one embodiment, the pocket comprises a lip configured to engage with a protrusion of the cap (not shown).

In one embodiment, one dosage unit is enclosed in each receptacle. In another embodiment, multiple dosage units to be taken in a single day are enclosed in each receptacle. The receptacles are horizontally arranged in two rows adjacent to one another. In one embodiment, the rows are organized into weeks such that each row comprises seven receptacles. Pill organizer 150 comprises indicia indicating the time and order in which the medications are to be taken by the patient. The indicia may include the day the dosage that should be taken according to a dosage regimen. In some embodiments, each receptacle is labeled with an arrow indicating the side which the receptacle lid is opened from. The indicia are screen printed onto pill organizer 150. In some embodiments, the indicia may be hand written. Sections of pill organizer 150 may be left blank to allow hand written notes or instructions by a patient, pharmacist or doctor.

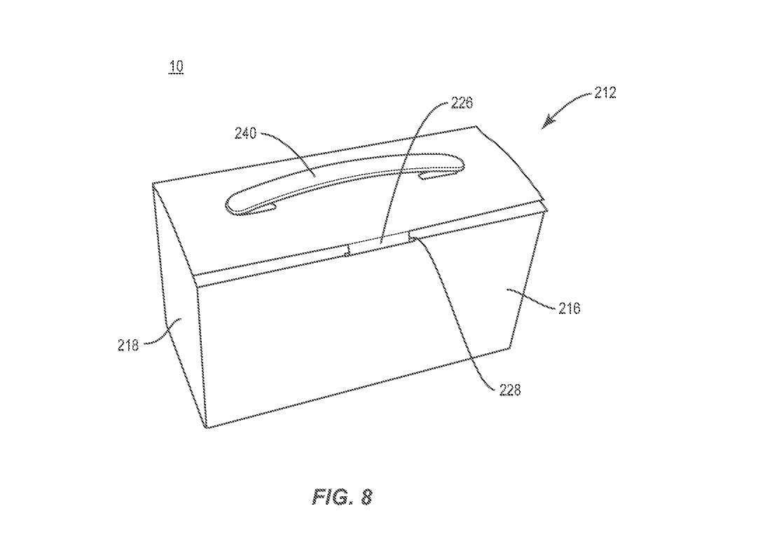

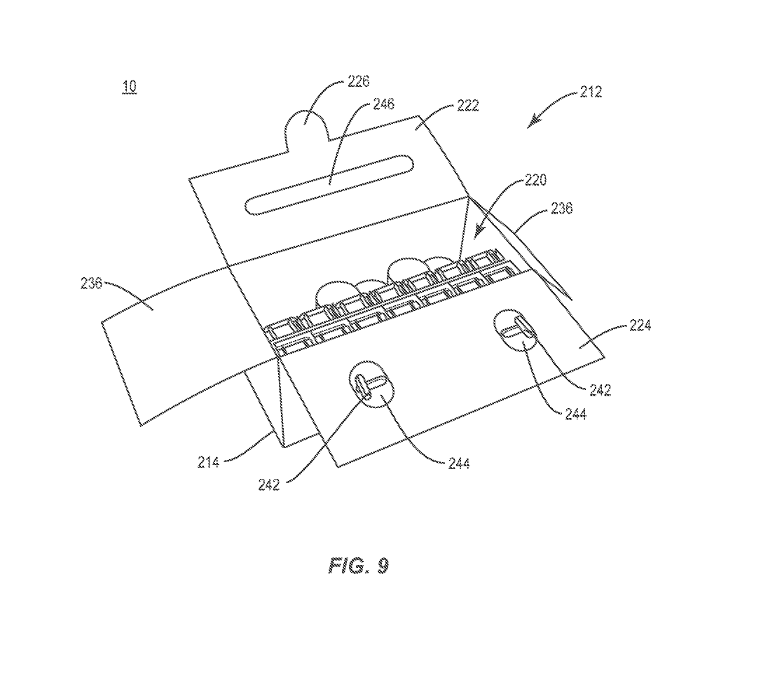

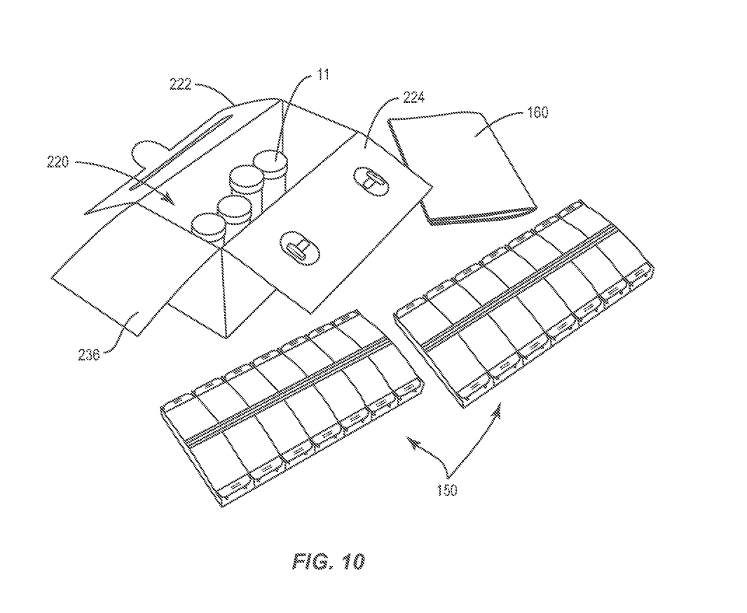

In some embodiments, as shown in FIGS. 8-10, medicament dispensing system 10, similar to the systems and methods of use of medicament dispensing system 10 described herein, includes a medicament dispensing device, such as, for example, a medicament packaging 212. Medicament packaging 212 is configured for disposal of one or a plurality of medication containers including a bottle and a cap. In some embodiments, medication containers include, such as, for example medication containers 11, as described herein. Medicament packaging 212 includes a bottom portion 214 and two pairs of oppositely positioned walls 216, 218. In one embodiment, medicament packaging 212 is a foldable box. Portion 214 and walls 216, 218 define a cavity 220. Cavity 220 is sized to receive medicaments stored in medication containers 11, pill organizers 150 and/or an insert 160, as described herein. Walls 216 are spaced apart from one another by a first distance, and walls 218 are spaced apart from one another by a second distance. In one embodiment, the first distance is greater than the second distance such that walls 216, 218 have a rectangular cross-sectional configuration. In other embodiments, the first and second distances are equal such that walls 216, 218 have a square cross-sectional configuration.

Medicament packaging 212 includes enclosure members, such as, for example, engageable flaps 222, 224, each attached to one of walls 216. Flaps 222, 224 are rotatable relative to walls 216 through an angular range of 0 through 360 degrees. In some embodiments, flaps 222, 224 include a rectangular profile to conform to the profile of medicament packaging 212. In some embodiments, flaps 222, 224 are configured to engage one another when medicament packaging 212 is in a closed configuration, as described herein. Flap 222 includes a tab 226. Flap 224 includes a slot 228, as shown in FIG. 8. Tab 226 may include alternate configurations, such as, for example, oval, oblong, triangular, rectangular, square, polygonal, irregular, uniform, non-uniform, variable, tubular and/or tapered. Tab 226 is oriented on flap 222 such that upon rotation of flap 222 toward flap 224, tab 226 slides into slot 228.

In some embodiments, medicament packaging 212 includes enclosure members, such as, for example, flaps 236 attached to walls 218. Flaps 236 are rotatable relative to walls 218 through an angular range of 0 through 360 degrees. In some embodiments, flaps 236 include a square or rectangular profile to conform to the profile of medicament packaging 212.

In some embodiments, flap 224 includes a handle 240 to facilitate portability of medicament packaging 212. Handle 240 includes a longitudinal profile and oppositely positioned extensions 242 extending transverse to handle 240. Flap 224 includes a pair of spaced apart slots 244 configured to receive extensions 242. In some embodiments, handle 240 comprises a flexible material to facilitate engagement of extensions 242 with slots 244. In some embodiments, flap 224 includes a reinforced material about slots 244 to increase the durability of medicament packaging 212 and a larger load of medications to be stored and carried in medicament packaging 212. In some embodiments, flap 222 includes an aperture 246 sized to allow a user to access handle 240 when medicament packaging 212 is in the closed configuration, as shown in FIG. 8.

Flaps 222, 224, 236 are rotatable between an open position, such as, for example, a medication accessible configuration and a closed position, such as, for example, a tamper resistant configuration, as described herein. In a closed configuration, portion 214, walls 216, 218, and flaps 222, 224, 236 define a substantially enclosed cavity 220 to prevent access to contents of medicament dispensing containers, such as, for example, medication containers 11 and/or pill organizers 150. In some embodiments, in a closed configuration, flaps 222, 224, 236 provide a child-resistant medicament dispensing container. In an open configuration, flaps 222, 224 are rotated relative to walls 216 and at least one flap 236 is rotated relative to wall 218 such that cavity 220 of medicament packaging 212 is exposed to facilitate ease of access to the contents of the cavity of medicament packaging 212.

When moving to the closed configuration, both flaps 236 are rotated toward one another to cover or partially cover cavity 220. Flaps 222, 224 are rotated toward one another such that flap 224 is covered by flap 222. In the closed configuration, handle 240 is accessible through aperture 246. When flaps 222, 224 converge, tab 226 aligns with and is inserted into slot 228 to a locked configuration. Slot 228 includes a narrow configuration to hold tab 226 in place by friction fit. In some embodiments, tab 226 includes a length that is greater than the length of slot 228 such that as medicament packaging 212 is moved between an open configuration and a closed configuration, engagement of tab 226 with slot 228 causes tab 226 to bow and/or flex to fit into slot 228. In some embodiments, tab 226 includes a flared portion configured to hook into flap 224 once tab 226 passes through slot 228.

In some embodiments, medicament packaging 212 may comprise indicia, such as, for example, instructions to aid a user patient in use of medicament packaging 212. The instructions may be presented in the form of a graphic, such as, for example, an arrow, or text, such as, for example, “insert here”. In some embodiments, the instructions may be printed onto a surface of flap 222. In some embodiments, the instructions may be printed onto one or more of walls 216, 218.

In some embodiments, medicament dispensing system 10 includes medication containers 11 and pill organizers 150, as described herein. In some embodiments, medicament dispensing system 10 includes an insert 160 configured to fit into cavity 220 when medicament packaging 212 is in the closed configuration to facilitate a doctor, pharmacist, health care personnel and/or patient creating personalized reminders and notes for a patient. In some embodiments, insert 160 comprises a notepad, a pamphlet or literature to educate a patient about a medication being administered in the dosage regimen. In some embodiments, insert 160 includes information to indicate the name and/or nature of the medicine being administered. In some embodiments, insert 160 includes a list of possible side effects of the medications being administered. In some embodiments, insert 160 provides instructions on how long a patient should take the medication being administered.

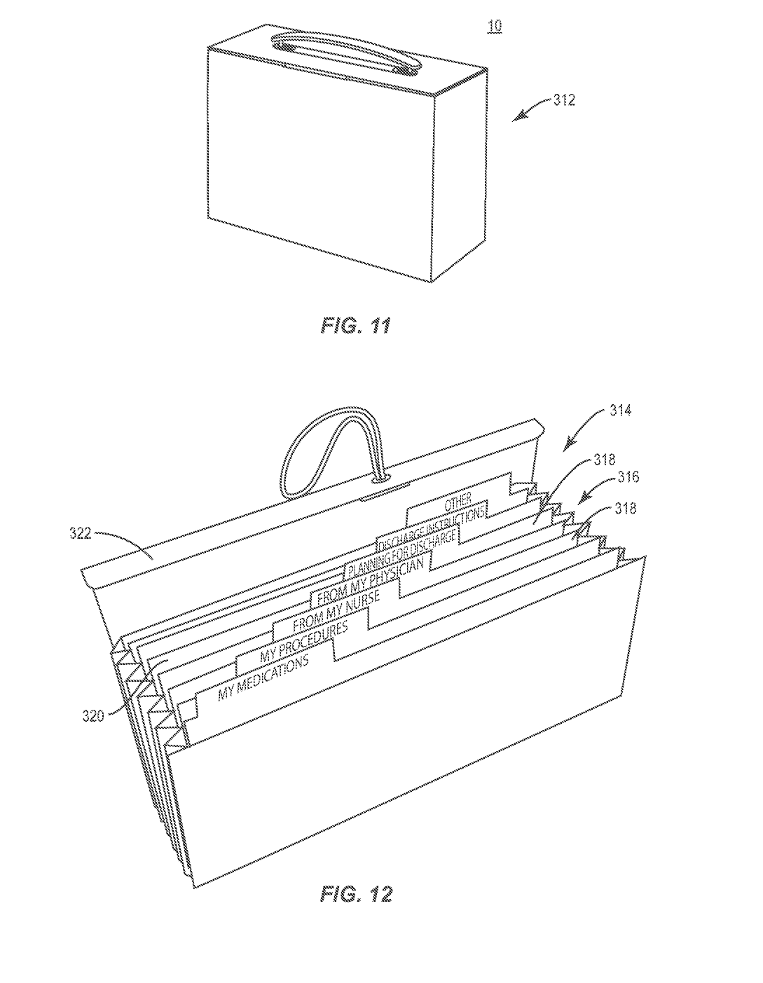

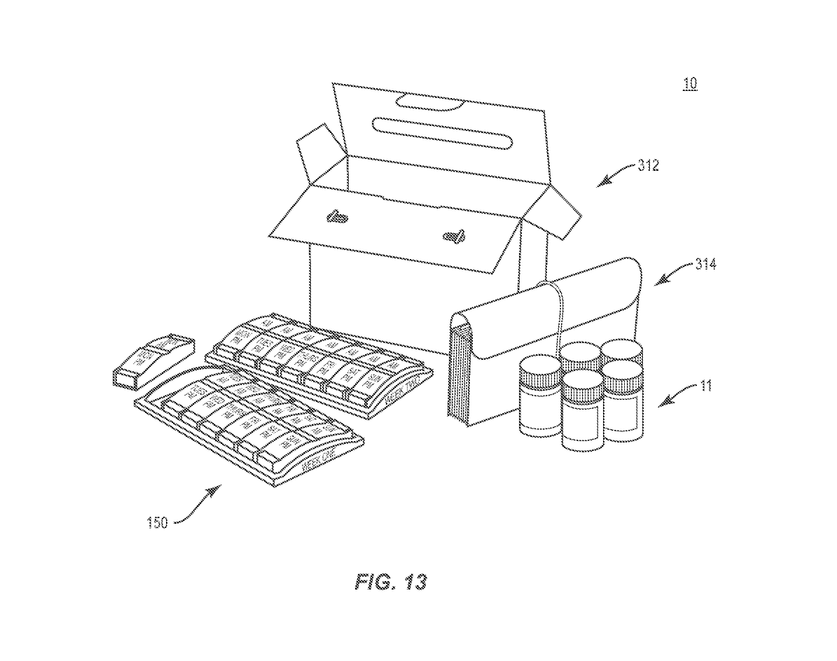

In one embodiment, as shown in FIGS. 11-13, medicament dispensing system 10, similar to the systems and methods of use of medicament dispensing system 10 described herein, includes a medicament dispensing device, such as, for example, a medicament dispensing container 312, similar to medicament packaging 212 described herein. In some embodiments, medicament dispensing system 10 includes a plurality of medication containers including a bottle and a cap. In some embodiments, medication containers include, such as, for example medication containers 11, as described herein. In some embodiments, medicament dispensing system includes pill organizers 150, as described herein

Medicament packaging 312 includes a receptacle, such as, for example, an organizer 314. Organizer 314 is divided into sections 316. Sections 316 include compartments 318 separated by partitions 320. In some embodiments, each compartment 318 is equally sized and configured. Organizer 314 includes a folder flap 322 attached to organizer 314. Flap 322 is pivotable relative to organizer 314. Compartments 318 are configured to includes various information to assist with proper medication administration, such as, for example, medication lists, procedures, notes for practitioners, patient plans and discharge, instructions and/or other patient and medicament information.

In some embodiments, organizer 314 is portable such that one or more receptacles can be transported and the remaining receptacles are maintained with a container, as described herein.

It will be understood that various modifications may be made to the embodiments disclosed herein. Therefore, the above description should not be construed as limiting, but merely as exemplification of the various embodiments. Those skilled in the art will envision other modifications within the scope and spirit of the claims appended hereto.

What is claimed is:

1. A medication container comprising:
a body comprising a neck portion and defining a cavity that includes at least one compartment; and
at least one closure member disposed with the neck portion in alignment with at least one of the at least one compartment, the at least one closure member being rotatable relative to the body,
wherein the at least one closure member is movable between a medication accessible configuration and a tamper resistant configuration.

2. A medication container as recited in claim 1, further comprising at least one partition configured to define the at least one compartment.

3. A medication container as recited in claim 1, wherein the at least one compartment includes a plurality of compartments, each of the compartments comprising equivalent dimension.

4. A medication container as recited in claim 1, wherein the at least one compartment includes a plurality of compartments, at least one of the compartments comprising a different dimension.

5. A medication container as recited in claim 1, wherein the body includes a transparent material.

6. A medication container as recited in claim 1, wherein the at least one closure member is dimensioned to fit the at least one compartment.

7. A medication container as recited in claim 1, wherein the at least one closure member is aligned with the at least one compartment

8. A medication container as recited in claim 1, wherein the at least one closure member is connected with the at least one compartment by a hinge.

9. A medication container as recited in claim 1, wherein the at least one closure member includes indicia.

10. A medication container as recited in claim 1, wherein the at least one closure member includes a gripping portion.

11. A medication container as recited in claim 1, wherein the at least one closure member includes a lock.

12. A medication container as recited in claim 1, further comprising at least one partition configured to define the at least one compartment and supports configured for disposal with the neck portion and aligned with the at least one partition.

13. A medication container as recited in claim 1, further comprising a lid configured for engagement with the neck.

14. A medication container as recited in claim 13, wherein the lid is child resistant.

15. A medication dispensing system comprising:
a container comprising a neck portion and defining a cavity that includes at least one compartment, and
at least one closure member disposed with the neck portion in alignment with at least one of the at least one compartment, the at least one closure member being rotatable relative to the body; and
at least one dose of at least one medication disposable in the at least one compartment,
wherein the at least one closure member is movable between a medication accessible configuration and a tamper resistant configuration.

16. A medication container as recited in claim 15, wherein the at least one closure member is connected with the at least one compartment by a hinge.

17. A medication container as recited in claim 15, wherein the at least one closure member includes indicia.

18. A medication container as recited in claim 15, wherein the at least one closure member includes a gripping portion.

19. A medicament dispensing system comprising:
a medicament packaging including a cavity and a closure member; and
at least one medication container configured for disposal within the cavity;
wherein the at least one closure member is movable between a medication accessible configuration and a tamper resistant configuration.

20. A medicament dispensing system as recited in claim 19, wherein the medicament packaging includes an organizer.
